(19) United States
(12) Patent Application Publication
(10) Pub. No.: US 2023/0196286 A1
(43) Pub. Date: Jun. 22, 2023

(54) UTILITY VEHICLE AND OPERATION

(71) Applicant: FORD GLOBAL TECHNOLOGIES, LLC, Dearborn, MI (US)

(72) Inventors: Jörg Christian Kirchhof, Hilden (DE); Detlef Kuck, Inden (DE); Jeroen Lem, Wittem (NL); Marcel Grein, Geilenkirchen (DE)

(21) Appl. No.: 18/079,953

(22) Filed: Dec. 13, 2022

(30) Foreign Application Priority Data
Dec. 17, 2021 (DE) 2021133576.0

(51) Int. Cl. G06Q 10/0875; G06T 7/00; G06T 7/70; G06T 7/20

(52) U.S. Cl. CPC G06Q 10/0875; G06T 7/0008; G06T 7/20; G06T 7/70; G06T 2207/30164; G06T 2207/30242; G06T 2207/30268

(57) ABSTRACT

A method and system for operating a utility vehicle, including detecting an insertion movement of a spare part box into an accommodation space of a shelf element in a load compartment of a utility vehicle; on detecting the insertion movement, capturing an image dataset indicative of the interior of the spare part box with a scanning unit assigned to the accommodation space; and evaluating the image dataset to determine the contents of the spare part box. A warning or replenishment order may be automatically generated when the number of a particular part is below a minimum threshold.

### CROSS REFERENCE TO RELATED APPLICATIONS

The present application claims the benefit to German patent application DE 102021133576.0, filed Dec. 17, 2021, the contents of which are incorporated herein in their entirety.

### BACKGROUND OF THE INVENTION

The invention relates in general to a method, a computer program product and a system for operating a utility vehicle, and a utility vehicle having a system of this type.

A person may keep an inventory of tools and components in a work vehicle they use to carry out work on customer premises. The inventory can comprise tools and components which are required for carrying out the respective work. The components may be larger components, e.g., components that are normally billed to the customer, but they may also be small parts, e.g., screws, bolts, and nails, i.e., consumables. Small parts of this type — since they are low-cost components — are typically not billed directly to the customer. In the case of small parts of this type, it is not easy to keep track of them, and it can occur in practice that a worker runs out of the small parts at the customer site. This results in considerable delays in the work, since the worker must find an office or wholesaler to reorder the missing small parts. Small parts of this type are often kept in a spare part box that is subdivided into compartments. The upper side of the spare part box is often transparent so that it is possible for the worker to generally determine the type of the small parts in their respective compartments and/or the quantities, in general, contained in the respective compartments without opening the spare part box. A spare part box of this type can be inserted into a correspondingly designed accommodation space of a shelf element in a load compartment of a utility vehicle, e.g., a small truck, and can thus be securely stored during a journey to a customer. Provisioning solutions having a shelf and a scanning unit are known in each case from US 10,878,373 B2, US 9,640,054 B2, 2018 / 0321660 A1, US 10,885,374 B2 and US 7,516,890 B1, which are incorporated herein by reference. There is a need to find ways of improving the small parts supply for workers when working at a remote site.

### SUMMARY OF THE INVENTION

An embodiment contemplates a method for operating a utility vehicle, which may include detecting an insertion movement of a spare part box into an accommodation space of a shelf element in a load compartment of a utility vehicle; on detecting the insertion movement, scanning an image dataset indicative of the interior of the spare part box with a scanning unit assigned to the accommodation space; and evaluating the image dataset in order to determine the contents of the spare part box.

An image dataset representing a replica of the compartments with the small parts located therein is therefore captured through e.g., a visually transparent lid of a spare part box having a plurality of compartments for storing different small parts, such as e.g., screws, bolts, or nails, when the spare part box is inserted into an accommodation space. A scanning unit, which can be a CDD sensor strip having a plurality of CCD sensor elements which are arranged in a row alongside one another, and which capture the image dataset line-by-line when the spare part box is inserted into the accommodation space, is used to scan the image dataset.

An image dataset is thus provided, through the evaluation of which the small parts supply of workmen on site can be improved.

According to one embodiment, at least a type of a small part is determined in a further step, e.g., a determination is made as to whether a small part is of the screw, bolt or nail type. In other words, the objects captured with the image dataset are classified and assigned to a respective group according to their determined type. A determination may also be made that subtypes or subgroups belong to a type or group, e.g., screws having different sizes and/or heads and/or threads. The inventory of small parts can thus be recorded accordingly in itemized form.

According to a further embodiment, the number of small parts is determined in a further step. This can be determined by itemizing the small parts according to their type. The stock of small parts can thus be recorded on site.

According to a further embodiment, the determined type of the small part and/or the determined number of small parts is used to update a stock dataset. A stock dataset is therefore managed and updated automatically. An up-to-date stock dataset is therefore always available.

According to a further embodiment, a warning signal is generated in a further step if a stocked quantity of small parts according to the stock dataset falls below a minimum threshold. To do this, for example, the inventory and/or stock of small parts of a specific type or subtype or group or subtype is compared with a respective, predetermined minimum threshold. If the number according to the determined inventory and/or stock is less than the minimum threshold, the warning signal is generated, giving an indication of the need to replenish the inventory or stock. The warning signal can be a visual and/or audible signal and/or a text message which is aimed directly at a worker and is displayed e.g., on a mobile device, such as e.g., a smartphone. The warning signal may furthermore accompany a machine-readable dataset in order to automatically initiate a replenishment of the stock below the threshold.

The invention further includes a computer program product and a system for operating a utility vehicle, and a utility vehicle having a system of this type.

### BRIEF DESCRIPTION OF THE DRAWINGS

FIG. 1 shows a schematic view of a load compartment of a utility vehicle.

FIG. 2 shows a schematic view of a spare part box.

FIG. 3 shows a schematic view of components of a system for the utility vehicle shown in FIG. 1.

FIGS. 4A and 4B shows a schematic view of further details of the components shown in FIG. 1.

FIG. 5 shows a schematic view of a method sequence for operating the system shown in FIGS. 1 to 4B.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Example embodiments may be described in the general context of computer-executable instructions, such as program code, software modules, and/or functional processes, being executed by one or more of the aforementioned circuitry. The program code, software modules, and/or functional processes may include routines, programs, objects, components, data structures, etc., that perform particular tasks or implement particular data types. The program code, software modules, and/or functional processes discussed herein may be implemented using existing hardware in existing communication networks. For example, program code, software modules, and/or functional processes discussed herein may be implemented using existing hardware at existing network elements or control nodes.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor” may refer to, is part of, or includes circuitry capable of sequentially and automatically carrying out a sequence of arithmetic or logical operations; recording, storing, and/or transferring digital data. The term “processor” may refer to one or more application processors, one or more baseband processors, a physical central processing unit (CPU), and/or any other device capable of executing or otherwise operating computer-executable instructions, such as program code, software modules, and/or functional processes.

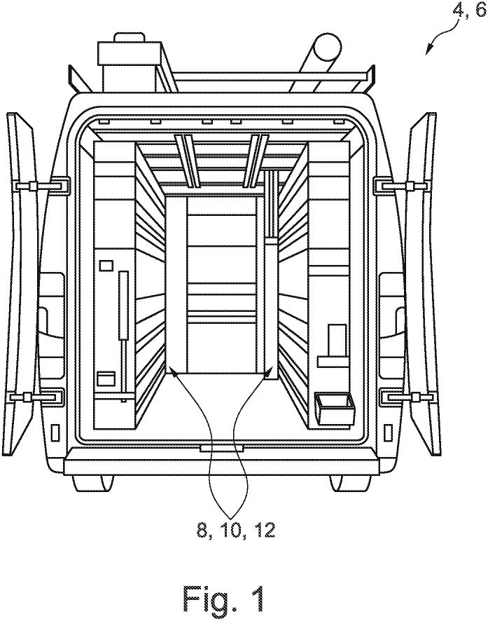

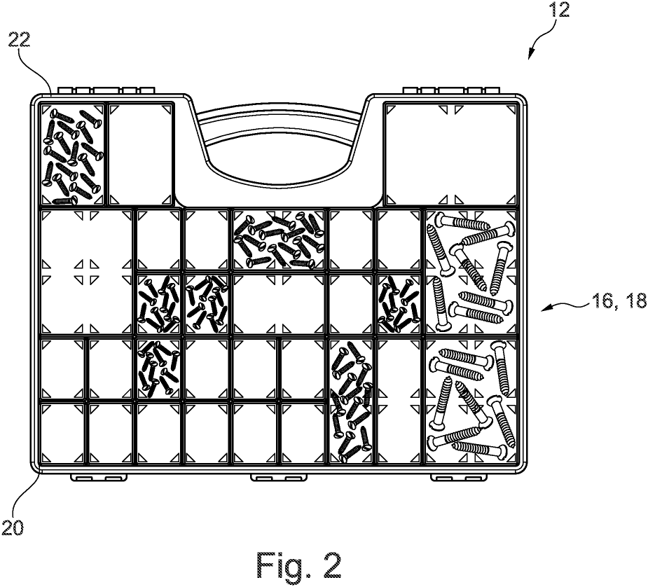

Reference is made first to FIG. 1. A utility vehicle 4 is shown, in the present example a small truck, of the type used e.g., by a worker in order to visit a customer and carry out work on site. The utility vehicle 4 has a load compartment 6 in which shelf elements 8 are arranged that serve to stock small parts 16, e.g., screws, bolts, and nails, (see FIG. 2), which may be needed to carry out work at the work site. Here, in the present example, the shelf elements 8 have a plurality of accommodation spaces 10, which are designed in each case to accommodate a spare part box 12.

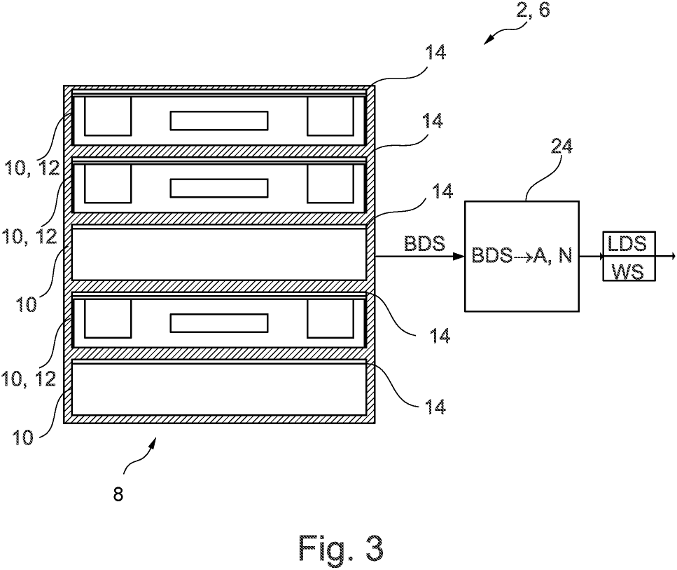

An example of a spare part box 12 of this type will now be described with additional reference to FIG. 2. The spare part box 12 has a base body 20 and a lid 22, which is attached in an articulated manner to the base body 20 and can be pivoted to open or close the spare part box 12. A plurality of compartments 18 are provided inside the spare part box 12 to store small parts 16. In the present example, the base body 20 and the lid 22 are made from a plastic material, wherein the lid 22 is made from a visually transparent plastic material, i.e., it is designed as translucent. An image dataset BDS (see FIG. 3) representing a replica of the compartments 18 with the small parts 16 located therein can thus be captured. In contrast to the present example, the spare part box 12 can also be designed, for example, without a carrying handle, such as a transport box or storage box.

A system 2 for operating a utility vehicle 4 with which the small parts supply of workers on site can be improved will be explained with additional reference to FIG. 3. The system 2 includes the shelf element 8 which, in the present example, has five accommodation spaces 10, wherein the spare part box 12 is inserted in each case in three of the five accommodation spaces 10. In contrast to the present example, the accommodation spaces 10 can also be arranged with a different alignment.

In the present example, the system 2 further includes five scanning units 14 which are assigned in each case to a respective one of the five accommodation spaces 10. In the present example, the scanning units 14 in each case have a charged coupled device (CDD) sensor strip having a plurality of CCD sensor elements that are arranged in a row alongside one another and are designed to capture the image dataset (BDS) line-by-line when the spare part box 12 is inserted into the respective accommodation space 10, as will be explained in further detail later. Each of the scanning units 14 may also include a sensor that detects the motion when the corresponding spare part box 12 is being slid into the respective accommodation space 10. In contrast to the present example, the scanning units 14 can also be designed differently. Furthermore, in contrast to the present example, a scanning unit 14 can also be assigned to a plurality of accommodation spaces 10.

In the present example, the system 2 further comprises an evaluation unit 24, which is arranged in the utility vehicle 4 and is designed to receive and evaluate the image dataset (BDS) from the scanning units in order to determine the contents of each of the spare part boxes 12. The evaluation unit 24 may determine at least a type A, a number N, or both, of the small parts 16 located in the spare part box 12 being scanned. The evaluation unit 24 may use the determined type A of the small part 16, the determined number N of small parts 16, or both, in order to update a stock dataset (LDS), and the evaluation unit 24 may generate a warning signal (WS) if a comparison reveals that a determined stocked quantity of one or more particular small parts 16, according to the stock dataset LDS, falls below a minimum threshold. The system 2, the scanning units 14 and the evaluation unit 24 has electronic circuitry, which may include hardware, software, or both for accomplishing these tasks and functions, which and tasks and functions are described below. The circuitry may also employ a processor for carrying out a sequence of operations, as described below.

The evaluation unit 24 may have components of an artificial intelligence, for example, an artificial neural network, for this purpose. Artificial neural networks (ANN) are networks consisting of artificial neurons. These neurons (also referred to as node points) of an artificial neural network are arranged in layers and are normally interconnected in a fixed hierarchy. The neurons are usually connected between two layers, but in rarer cases within a layer also. Artificial neural networks of this type are first fed with training data during a training phase in order to train them. Training data can be image data of small parts in spare part boxes, wherein the artificial neural network is trained during the training phase to correctly determine the type A, the number N, or both, of the small parts 16. However, unsupervised learning can also be used for training, along with supervised learning of this type. After the training phase, the artificial neural network trained in this way can determine the type A, the number N, or both, of the small parts 16.

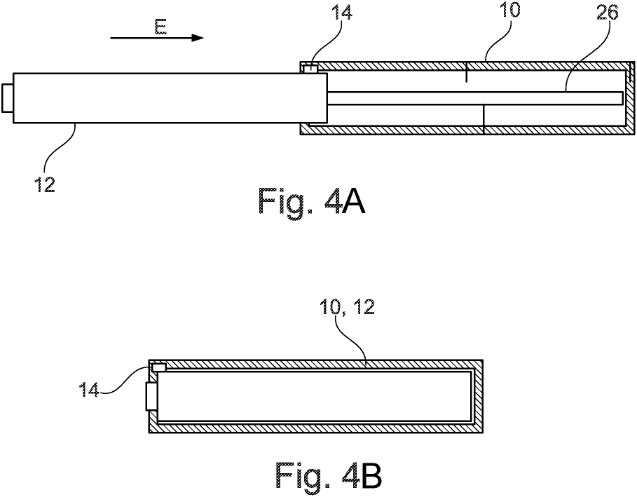

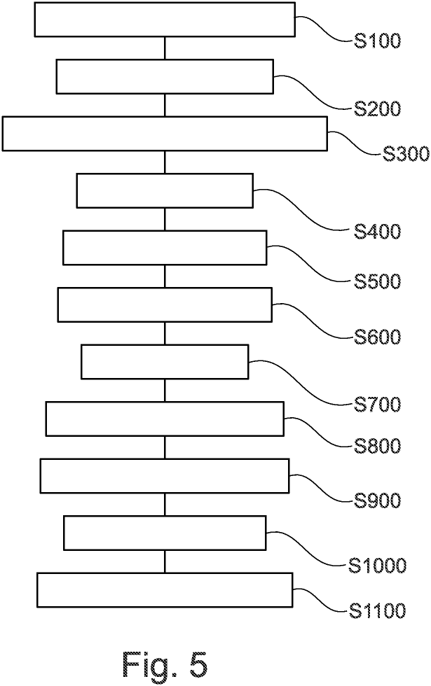

Reference is now additionally made to FIGS. 4A, 4B and 5. In the present example, the spare part box 12 is shown to be engaged with a guide rail 26 inside the accommodation space 10. The engagement and movement can be detected e.g., with a corresponding motion sensor of the corresponding scanning unit 14 (or other sensor capable of detecting the sliding of the spare part box 12 into its corresponding accommodation space 10, which sensors are known to those skilled in the art), and trigger the scanning by the scanning unit 14 to create an image dataset (BDS). The sensor may detect the engagement in response to contact or without requiring contact (e.g., through evaluation of image data of an internal camera (e.g., a CCD sensor), with ultrasound sensors or through detection of Bluetooth tags).

The spare part box 12 is pushed in the direction of the insertion movement E (shown in FIG. 4A) into the accommodation space 10. During this displacement movement, the scanning unit 14 scans through the lid 22 to create the image dataset (BDS). This scanning may be accomplished line-by-line as the spare part box 12 is slid into the respective accommodation space 10. Once the spare part box 12 has reached the final position (shown in FIG. 4B), this is similarly detected with the motion sensor of the scanning unit 14 (or a different sensor capable of detecting the spare part box 12 reaching its final position (i.e., a closed position), which types of sensors are known to those skilled in the art). Upon reaching the final position, that particular scanning process is ended. This sensor can also end the process in response to contact or can detect it without requiring contact.

The evaluation unit 24 receives and evaluates the image dataset (BDS). The spare part box 12 can further be provided with a tag (simple QR code, Bluetooth tag, RFID tag, etc.), so that spare part boxes 12 can be exchanged between the accommodation spaces 10 and, through acquisition and evaluation of position data relating to the position of the respective spare part box 12, said position can be determined. The spare part box 12 may be color-coded, e.g., on one of its sides. In this way, it is possible to keep track of the locations of the spare part boxes 12 in the various accommodation spaces 10, and the determination of the size of the individual spare part boxes 12 is simplified for the evaluation unit 24.

An example of a method for operating the system 2 will be explained with reference to FIG. 5, in view of FIGS. 1 to 4B. In step S100, the spare part box 12 is brought into the load compartment 6 of the utility vehicle 4. This may be accomplished by a worker who uses small parts 16 from the spare part box 12.

In step S200, the automated detection of the contents of the spare part box 12 is then started. In step S300, the spare part box 12 is engaged with the guide rail 26 inside one of the accommodation space(s) 10 in one of the shelf element(s) 8 of the load compartment 6 of the utility vehicle 4. This may be accomplished by a worker. In step S400, the insertion movement E of the spare part box 12 into the accommodation space 10 is automatically detected by a sensor of the corresponding scanning unit 14. In step S500, in response to the automatic detection of the insertion movement E, the image dataset BDS is automatically captured with a sensor of the scanning unit 14 of the corresponding accommodation space 10. In step S600, a sensor of the scanning unit detects that the spare part box 12 has reached its final position, at which point the scanning process automatically ends, and the scanning unit 14 transmits the image dataset BDS to the evaluation unit 24.

In step S700, the evaluation unit then evaluates the received image dataset BDS to determine the contents of the spare part box 12. In step S800, the evaluation unit 24 determines at least a type A of a small part 16 for each (or at least one) compartment 18 of the spare parts box 12. In step S900, the evaluation unit 24 determines the number N of small parts 16 for each (or at least one) compartment 18 of the spare parts box. In step S1000, the evaluation unit 24 updates a stock dataset LDS for the determined type A of the small part(s) 16 or the determined number N of small parts 16, or both. In step S1100, the evaluation unit 24 may automatically generate the warning signal WS, automatically re-order new small parts 16, or both, when a stocked quantity of one or more particular small parts 16 according to the stock dataset LDS falls below a respective minimum threshold. There may be different minimum thresholds for different types of parts A, with the warning indicating which type(s) of small parts are below their respective minimum thresholds.

In addition to the example illustrated in the figures, the sequence of the steps can also be different. A plurality of steps can furthermore also be carried out concurrently or simultaneously. Furthermore, also in contrast to the present example, individual steps can be skipped or omitted. An image dataset is thus provided, through the evaluation of which the small parts supply of a vehicle on a work site can be improved.

While certain embodiments of the present invention have been described in detail, those familiar with the art to which this invention relates will recognize various alternative designs and embodiments for practicing the invention as defined by the following claims.

1. A method for operating a utility vehicle, comprising:
automatically detecting, with a sensor of a scanning unit operatively engaging an accommodation space, an insertion movement of a spare part box into the accommodation space of a shelf element in a load compartment of the utility vehicle;
upon detecting the insertion movement, automatically capturing, with a second sensor of the scanning unit, an image dataset of an interior of the spare part box;
automatically determining a number of at least one type of small part of the spare part box by evaluating, with an evaluation unit, the captured image dataset; and
automatically updating, with the evaluation unit, a stock dataset for the determined number of the at least one type of the small part.

2. The method according to claim 1, further comprising, determining, with the evaluation unit, at least two types of a small parts and the numbers of each of the at least two types of small parts based on the captured image dataset.

3. The method according to claim 2, further comprising, automatically updating, with the evaluation unit, the stock dataset with the number for each of the at least two types of small parts.

4. The method according to claim 2, further comprising, automatically generating a warning signal when the number of small parts for at least one of the at least two types of small parts is below a minimum threshold for that particular small part.

5. The method according to claim 4, further comprising, automatically ordering a replenishment of the particular small part of the at least two types of small parts that are below the minimum threshold.

6. The method according to claim 1, further comprising:
automatically detecting, with a third sensor of a second scanning unit operatively engaging a second accommodation space, an insertion movement of a second spare part box into the second accommodation space of the shelf element in the load compartment of the utility vehicle;
upon detecting the insertion movement, automatically capturing, with a fourth sensor of the second scanning unit, a second image dataset of an interior of the second spare part box;
automatically determining a number of at least one type of small part of the second spare part box by evaluating, with the evaluation unit, the second captured image dataset; and
automatically updating, with the evaluation unit, the stock dataset for the determined number of the at least one type of the small part of the second spare part box.

7. The method according to claim 6, further comprising, automatically generating a warning signal when the number of small parts for at least one type of small parts is below a minimum threshold for that particular small part in the second spare part box.

8. The method according to claim 6, further comprising, automatically ordering a replenishment of the particular small part of the at least one type of small part when a number of the at least one type of small part is below a minimum threshold.

9. The method according to claim 1, further comprising:
automatically determining, with the scanning unit, when the insertion movement begins and when the insertion movement stops; and automatically capturing, with the scanning unit, the image dataset from when the insertion movement begins to when the insertion movement stops.

10. The method according to claim 1, further comprising the spare part box including at least two compartments, and automatically determining the number of the at least one type of small part in each of the at least two compartments of the spare part box by evaluating, with the evaluation unit, the captured image dataset.

11. The method according to claim 10, further comprising, automatically generating a warning signal when the number of small parts for the at least one type of small part is below a minimum threshold for that particular small part in any of the at least two compartments.

12. A system for operating a utility vehicle comprising:
a shelf element located in the utility vehicle and including an accommodation space configured to slidingly receive a spare part box having a side configured to allow for generation of an image of small parts located within the spare part box;
a scanning unit operatively engaging the accommodation space that is configured to slidingly receive the spare parts box, the scanning unit including a sensor configured to detect when the spare part box is being inserted into the accommodation space and a second sensor configured to automatically capture an image dataset of an interior of the spare part box as the spare part box is inserted into the accommodation space; and
an evaluation unit configured to automatically receive the image dataset, determine a number of at least one type of small part of the spare part box by evaluating the image dataset, and updating a stock dataset for the determined number of the at least one type of the small part.

13. The system according to claim 12, wherein the evaluation unit is further configured to automatically generate a warning signal when the number of small parts for the at least one type of small part is below a minimum threshold for that particular small part in the spare part box.

14. The system according to claim 12, wherein the evaluation unit is further configured to automatically order a replenishment of the particular small part of the at least one type of small part when a number of the at least one type of small part is below a minimum threshold.

15. The system according to claim 12, further comprising:
the shelf element located in the utility vehicle including a second accommodation space configured to slidingly receive a second spare part box having a side configured to allow for generation of an image of small parts located within the second spare part box;
a second scanning unit operatively engaging the second accommodation space that is configured to slidingly receive the second spare parts box, the second scanning unit including a third sensor configured to detect when the second spare part box is being inserted into the second accommodation space and a fourth sensor configured to automatically capture a second image dataset of an interior of the second spare part box as the second spare part box is inserted into the second accommodation space; and
wherein the evaluation unit configured to automatically receive the second image dataset, determine a number of at least one type of small part of the second spare part box by evaluating the second image dataset, and updating the stock dataset for the determined number of the at least one type of the small part in the second spare part box.

16. The system according to claim 12, wherein the spare part box includes at least two compartments, and the evaluation unit is configured to automatically determine the number of the at least one type of small part in each of the at least two compartments of the spare part box by evaluating the captured image dataset.

17. The system according to claim 16, wherein the evaluation unit is configured to automatically generate a warning signal when the number of small parts for the at least one type of small part is below a minimum threshold for that particular small part in any of the at least two com partments.

18. The system according to claim 17, wherein the evaluation unit is configured to automatically order a replenishment of the particular small part of the at least one type of small part when the number of the at least one type of small part is below a minimum threshold for that particular small part in any of the at least two compartments.
